(19) United States
(12) Patent Application Publication
(10) Pub. No.: US 2005/0208387 A1
(43) Pub. Date: Sep. 22, 2005

(54) Optical recording material, optical recording medium and optical recording/reproducing apparatus

(75) Inventors: Jiro Minabe, Ashigarakami-gun (JP); Tatsuya Maruyama, Minato-ku (JP); Hiroo Takizawa, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/959,989

(22) Filed: Oct. 8, 2004

(30) Foreign Application Priority Data
Mar. 22, 2004 (JP) 2004-83716

(51) Int. Cl. G03H 1/02; G11B 7/24

(52) U.S. Cl. 430/1; 430/2; 430/19; 430/945; 359/4; 359/3; 369/275.2; 428/64.8

(57) ABSTRACT

An optical recording material which includes at least one of a polymer and an oligomer, the at least one of a polymer and an oligomer comprising a photoresponsive group. The optical recording material records information through change in at least one of absorption, refractive index and shape due to irradiation of light thereto. A main chain of the at least one of a polymer and an oligomer has a side chain comprising a mesogenic unit linked thereto. The side chain comprises at least two flexible spacer groups introduced thereto, the spacer groups having lengths different from each other.

### CROSS-REFERENCE TO RELATED APPLICATION

This application claims priority under 35USC 119 from Japanese Patent Application No. 2004-83716, the disclosure of which is incorporated by reference herein.

### BACKGROUND OF THE INVENTION

1. Field of the invention

The present invention relates to an optical recording material, an optical recording medium and an optical recording/reproducing apparatus, particularly to a three-dimensional optical recording medium having a large storage capacity, an optical recording material used for the optical recording medium, and an optical recording/reproducing apparatus for recording and reproducing information using the optical recording medium.

2. Description of the Related Art

Conventional optical disk storage apparatus has been devised to reduce the distance between adjoining tracks or pits by reducing the diameter of beam spots in order to enhance recording density. However, since the distance has approached a physical limit (5 Gbit/in²) of high density recording due to being restricted by a diffraction limit of the light for recording data on a plane of an optical disk, three-dimensional recording (volume recording) including recording in the depth direction is necessary for further increasing the recording capacity.

An example of a promising optical volume recording medium is a medium composed of an optical refractive index variable material comprising a hologram lattice capable of three-dimensional recording. A known example of a photorefractive material (referred to as a “PR material” hereinafter) has high sensitivity and undergoes a change in the refractive index by absorbing relatively weak light at a level of a solid laser, and such material is expected to be applied to three-dimensional multiple hologram recording (holographic memory) having ultra-high recording density and extremely large storage capacity.

The principle of the photorefractive effect will be described below. Two coherent light waves are irradiated to the PR material to create interference. Electrons at a donor level are excited to a conduction band at a site irradiated with intense light and are transferred by diffusion or drift and trapped at a site irradiated with weak light. Consequently, positive charges are left behind at the site irradiated with the intense light, while negative charges are accumulated at the site irradiated with the weak light to thereby form a charge distribution that generates an electrostatic field. The refractive index changes as a result of the electrooptical effect by the electrostatic field. Since the frequency of the refractive index change is the same as the frequency of the interference pattern, this refractive index lattice functions as a hologram diffraction lattice.

Hitherto, inorganic ferroelectric crystals such as barium titanate, lithium niobate and bismuth silicate (BSO) have been used as PR materials. Although these materials exhibit a light-induced refractive index changing effect (photorefractive effect) with high sensitivity and high efficiency, they exhibit such defects that crystal growth thereof is often difficult, machining into a desired shape is impossible since most of these materials are hard and fragile, and adjustment of sensitive wavelength is difficult.

Organic PR materials comprising organic substances have been proposed in recent years for overcoming these defects. An organic PR material usually comprises (i) a charge generating material for generating a charge by receiving light, (ii) a charge transfer material for transferring the generated charge in a medium, (iii) a dichroic organic pigment reactive to an electric field induced by charge transfer, (iv) a polymer substrate (binder) for retaining these materials, and (v) additives for changing the properties of the substrate (such as a plasticizer and compatibilizer). One component may serve as plural materials such as the charge transfer material and polymer substrate, and the charge transfer material and plasticizer.

These organic PR materials generate positive and negative charges from a charge generating material by absorbing light, and the positive and negative charges are separated by the charge transfer material by the action of an external electric field to generate an inner electric field. Orientation of the dichroic dye is changed by this inner electric field to cause a change in the distribution of the refractive index in the substrate. Three-dimensional hologram recording with a high recording density is possible in principle by applying such an organic PR material.

However, this organic PR material has a problem in that it is essential to apply an outer electric field. Since the electric field is as large as several hundred V·mm⁻¹, this is a large restriction on the apparatus when utilizing such a system as a recording apparatus. Moreover, since various different materials such as the charge generating material, charge transfer material and polymer substrate are used in combination, a decrease in stability due to phase separation during recording or preservation is another large problem.

For avoiding the problems described above, S. Hvilsted et al. have proposed to use a polymer having cyanoazobenzene in a side chain, whereby a lattice of refractive index is written on the polymer to record the hologram (for example, see Opt. Lett., 17[17], 12 (1992)). This material is able to write 2,500 lines of undulations of the lattice in a 1 mm interval, and is expected to afford high recording density.

A holographic memory of a polymer film having azobenzene at the side chain takes advantage of light-induced anisotropy of a polymer film. While azobenzene in an amorphous azo-polymer film is randomly oriented, a trans-isomer of azobenzene is excited with a higher probability as transition dipole moments are aligned in the polarization direction of the light, or selectively excited, by irradiating linearly polarized excitation light having a wavelength corresponding to that of an absorption band assigned to π-π* transition of the azo group to the azo-polymer film to cause photo-isomerization of the trans-isomer into a cis-isomer. The excited cis-isomer is isomerized into the trans-isomer again by light or heat.

Orientation of azobenzene changes in a direction that is stable with respect to the excitation light, or in a direction perpendicular to the polarized light, through an angle-selective trans-cis-trans isomerization cycle due to irradiation of the polarized light. Since azobenzene is optically anisotropic, it exhibits birefringence and dichroism as a result of the change in orientation. Holographic recording by intensity distribution and polarization distribution is possible by taking advantage of this light-induced anisotropy. Recording is stable for a long period of time since it depends on the change in polymer orientation, and repeated recording is possible by erasing the recorded information by irradiating circular polarized light or by a phase change to an isotropic phase by heating. The polymer film having azobenzene at the side chain is most promising as a rewritable holographic memory material.

While a holographic recording material using an azobenene-containing polymer having azobenzene site of a specified structure in a side chain and having a main chain of an acrylate or methacrylate structure has been disclosed with respect to the materials above, the material still has the problems described below. Since forming a thick recording medium for realizing a high diffraction efficiency is difficult, the polymer is insufficient as a material for an optical recording material having high recording density and high sensitivity (see, for example, Japanese National Publication Nos. 2000-514468 and 2002-539476, U.S. Pat. No. 6,441,113 B1 and Japanese Patent Application Laid-Open (JP-A) No. 10-212324). Accordingly, it has been difficult for the conventional azobenzene-containing polymer materials to form a thick medium for use as a three-dimensional hologram material for forming plural holograms in the optical recording material, or to achieve high speed recording of digital data by realizing a high diffraction efficiency. A thickness of about 40 μm has been a limit of the thickness of practically available media (for example, see H. J. Coufal, D. Psaltis and G. T. Sincerbox eds.: Holographic data Storage, Springer, p. 222 (2000)).

On the other hand, the present inventors have proposed polyester having azobenzene in a side chain that is useful as the optical recording material as described above. In particular, the inventors have disclosed monomers and polyester in which the absorption band is controlled to within a range suitable for optical recording by introducing a methyl group into azobenzene, and an optical recording medium using the same (for example, see JP-A No. 2000-109719). The inventors have also proposed a polyester suitable for optical recording in which a glass transition temperature of the polymer is controlled by restricting the methylene main chain, and an optical recording medium using the same (for example, see JP-A No. 2000-264962). It has been also disclosed that optical recording properties are improved by using a polyester in which methylene chains of the side chain are restricted (for example, see JP-A No. 2001-294652).

“Thickening of the recording medium” is most important for realizing large storage capacity in the three-dimensional holographic memory. Conditions for incident light angles for allowing the light to diffract become severe in a thick hologram, and the diffraction light is quenched even by a small deviation of the diffraction angle from Bragg's condition. The multiple angle method in the three-dimensional holographic memory takes advantage of this angle selectivity. In other words, reading arbitrary holograms without cross-talk is possible by forming plural holograms in the same volume, and by controlling the incident angle of the reading light. Multiplicity may be enhanced while the recording capacity is increased by improving angle selectivity as a: result of increased thickness of the recording medium.

The magnitude of modulation of the refractive index for forming the hologram is restricted by the ability of medium materials. Accordingly, forming plural holograms in the same volume corresponds to using the refractive index modulation ability of the material by dividing it among the plural holograms. Since the amplitude of the refractive index functions approximately proportional to the square thereof on the diffraction efficiency, the diffraction efficiency of the hologram decreases in inverse proportion to the square of multiplicity when multiplicity is improved. Therefore, developments in recording media that are able to obtain a somewhat higher level of diffraction efficiency are desired when multiplicity is improved.

The polymer film having azobenzene in its side chain should be recorded at a wavelength capable of exciting π-π* transition of azobenzene considering the mechanism as described above. While selecting a wavelength having a high absorption is effective for improving recording sensitivity, other problems also occur. When a material having a high absorption at the recording wavelength is used, the incident recording light is absorbed by the molecules near the surface of the material, and effective holograms cannot be formed across the entire medium in the thickness direction of the medium. It is known that angular selectivity of the diffraction efficiency is deteriorated when the amplitude of the refractive index of the hologram is attenuated in the thickness direction. Deterioration of angular selectivity causes cross-talk among the multiple recorded holograms to decrease S/N ratios. Furthermore, realizing a high diffraction efficiency becomes difficult due to absorption loss of the medium.

While the rising speed of light-induced birefringence is high when spacers are short in an optical recording material using polyester having methylene chains as spacer groups (may be referred to as “main chain spacers” and “side chain spacers” hereinafter) introduced into the main chain and side chain, respectively, the saturation level is small since the restriction force of the main chain against the side chain is large. On the other hand, although the rising speed is low when the spacer group is long, orientation of the side chain is able to be largely changed due to the long spacer group, and the polymer shows large birefringence. Accordingly, it has been difficult to make high sensitivity compatible with a high dynamic range.

### SUMMARY OF THE INVENTION

The present invention has been made in view of the above-described circumstances and provides an optical recording material that is able to maintain high recording sensitivity, wide dynamic range and high diffraction efficiency by controlling the length of side chain spacers in order to increase the thickness of the film. The invention also provides an optical recording medium capable of larger recording capacity by increasing the thickness of a photosensitive layer without impairing recording property. The invention further provides an optical recording/reproducing apparatus having large data capacity.

A first aspect of the invention is to provide an optical recording material which comprises at least one of a polymer or an oligomer. The at least one of a polymer or an oligomer comprises photoresponsive group. The optical recording material records information through change in at least one of absorption, refractive index and shape due to irradiation of light thereto. A main chain of the at least one of a polymer and an oligomer has a side chain comprising a mesogenic unit linked thereto. The side chain comprises at least two flexible spacer groups introduced thereto, the spacer groups having lengths different from each other.

A second aspect of the invention is to provide an optical recording medium comprising a photosensitive layer including the optical recording material of the first aspect.

A third aspect of the invention is to provide an optical recording/reproducing apparatus for recording and/or reproducing information using the optical recording medium of the second aspect.

The invention provides an optical recording material maintaining high recording sensitivity, wide dynamic range and high diffraction efficiency in order to increase the thickness of the film. The invention also provides an optical recording medium capable of large capacity recording without impairing recording property, and an optical recording/reproducing apparatus capable of recording and reproducing large capacity data.

### BRIEF DESCRIPTION OF THE DRAWINGS

FIG. 1 is a schematic diagram illustrating a first example of the optical recording/reproducing apparatus of the present invention.

FIG. 2 is a cross sectional view illustrating the structure of spatial light modulator used for the optical recording/reproducing apparatus of the invention.

FIG. 3 is a schematic diagram illustrating a second example of the optical recording/reproducing apparatus of the invention.

FIG. 4 is a graph illustrating the change in diffraction efficiency against the exposure energy.

FIG. 5 is a schematic diagram illustrating a third example of the optical recording/reproducing apparatus of the invention.

FIG. 6 is a graph illustrating the change in light-induced birefringence against the exposure energy.

FIG. 7 is a graph illustrating the relation among the blending ratio of photoresponsive polyester, sensitivity and birefringence.

FIG. 8 is a graph illustrating the relation between the blending ratio of photoresponsive polyester and (sensitivity×birefringence).

FIG. 9 is a graph illustrating the change in the diffraction light intensity against deviation from the Bragg angle.

FIG. 10 is a graph illustrating the relation between the absorption coefficient and attenuation coefficient of grating.

### DETAILED DESCRIPTION OF THE INVENTION

The present invention will be described in detail hereinafter.

<Optical Recording Material>

The optical recording material of the invention comprises at least one of a polymer or oligomer. The at least one of a polymer and an oligomer comprises a photoresponsive group. The optical recording material records information through change in at least one of absorption, refractive index and shape due to irradiation of light thereto. A main chain of the at least one of a polymer and an oligomer has a side chain comprising a mesogenic unit linked thereto. The side chain comprises at least two flexible spacer groups introduced thereto, the spacer groups having lengths different from each other.

The photoresponsive group undergoes structural change such as geometrical isomerization due to irradiation of light thereto. While examples of the group include those having an azobenzene skeleton, a stilbene skeleton and an azomethine skeleton (details thereof will be described below), the group preferably contains the azobenzene skeleton.

The mesogenic unit is preferably a linear mesogenic unit which is usually used as the mesogenic unit for low molecular weight liquid crystals. The examples thereof include biphenyl-base groups including p-substituted aromatic rings, terphenyl-base groups, benzoate ester-base groups, cyclohexane carboxylate ester-base groups, phenyl cyclohexane-base groups, pyrimidine-base groups, dioxane-base groups and cyclohexyl cyclohexane-base groups. Among them, those containing a biphenyl skeleton (biphenyl derivatives) can be preferably used.

The photoresponsive group such as azobenzene may be included in the mesogenic unit in the invention.

The optical recording material of the invention is featured as follows. Both high sensitivity and wide dynamic range are achieved by the main chain having a mesogenic unit-containing side chain, and by introducing to the side chain at least two flexible spacer groups having lengths different from each other.

It becomes possible by introducing at least two kinds of flexible spacer groups having lengths different from each other as the side chain to accelerate rising of light-induced birefringence to a certain extent with the relatively short spacer group and to obtain a large saturation level of birefringence with the relatively long spacer groups. Consequently, high sensitivity and wide dynamic range can be achieved even when the thickness of the film is increased.

The term “flexible spacer groups” refers to plural linked atoms such as ether bonds and methylene chains having flexibility to an extent capable of moving by molecular motion more than a certain degree.

In order to achieve both rapid rising of light-induced birefringence and a large saturation level, a methylene group having 2 to 12 carbon atoms is preferably introduced as the relatively short spacer group, and a methylene group having 4 to 20 carbon atoms is preferably introduced as the relatively long spacer group.

The ratio of the long spacer group to the short spacer group (carbon number of the long spacer group/carbon number of the short spacer group) is preferably in the range of 9/10 to 10/1, and more preferably in the range of 6/4 to 4/1.

The phrase “introducing at least two kinds of flexible spacer groups having lengths different from each other as the side chain” as used herein refers to the existence of side chains having at least two kinds of flexible spacer groups having lengths different from each other in the entire polymer or oligomer.

Accordingly, the spacer groups having lengths different from each other may be introduced into the side chain by linking plural side chains containing flexible spacer groups having lengths different from each other to one polymer main chain, or by mixing polymers or oligomers each containing a flexible spacer group, the flexible spacer groups having lengths different from each other. In a case of mixture, the optical recording material may comprise a mixture of at least two kinds selected from polymers and oligomers each having a side chain comprising a flexible spacer group having lengths different from each other introduced thereto. Such polymer may exert the same effect as a polymer into which flexible spacer groups having lengths different from each other are introduced. In case using a mixture, the lengths of the spacer groups, the ratio of the long spacer groups to short spacer groups, and the content of the spacer groups are preferably the same as recited in the above.

All or a part of the mesogenic units are preferably the photoresponsive groups in the invention. This allows orientation changes of the polymer or oligomer to be efficiently induced from the structural changes based on a photochemical reaction of the photoresponsive groups.

Specific examples of the mesogenic unit as a basis of the photoresponsive group will be described later.

The proportion of the mesogenic unit as the photoresponsive group is preferably in the range of 0.01 to 80% by mole, and more preferably in the range of 1 to 60% by mole based on the total mesogenic units.

It is preferable in the invention that the at least one of a polymer and an oligomer comprises a side chain having a mesogenic unit that is a photoresponsive group and a side chain having a mesogenic unit that is a non-photoresponsive group. Moreover, the spacer group of the side chain having a mesogenic unit that is a photoresponsive group and the spacer group of the side chain having a mesogenic unit that is a non-photoresponsive group preferably have lengths that are different from each other.

In this case, it becomes possible to independently control the mobility of the photoresponsive group capable of directly changing its structure due to irradiation of light and the mobility of the none-photoresponsive group capable of changing its orientation as a result of the structural change of the photoresponsive group.

The length of the spacer group of the side chain having a mesogenic unit that is a photoresponsive group is preferably shorter than the length of the spacer group of the side chain having a mesogenic unit that is a non-photoresponsive group. By shortening the length of the spacer group linked to the mesogenic unit that is a photoresponsive group, the rising speed of light-induced birefringence can be increased. By lengthening the length of the spacer group linked to the mesogenic unit that is a non-photoresponsive group, the saturation level of birefringence can be increased.

The preferable lengths of long and short spacers, the ratio between the long and short spacer groups, and the content ratio thereof are the same as recited in the above.

The polymer or oligomer of the invention containing a site of the photoresponsive group will be described in detail hereinafter.

The polymer or oligomer of the invention containing a photoresponsive group is preferably a compound represented by the following formula (1): 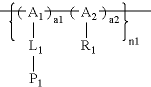
wherein L₁ represents a divalent linking group; R₁ represents a hydrogen atom or a substituent; P₁ represents a group comprising a site of the photoresponsive group; a1 and a2 represent numbers in a range of 0.0001 to 1 and in a range of 0 to 0.9999, respectively, and satisfy a1+a2=1; and n1 represents an integer in a range of 4 to 2000.

The phrase of “introducing at least two flexible spacer groups having lengths different from each other” indicates that at least two kinds of L₁s having lengths different from each other are introduced, or that the length of the spacer group R₁ including a mesogenic unit is different from the length of L₁.

L₁ in formula (1) represents a divalent linking group. L₁ represents a linking group having 0 to 100 carbon atoms, and preferably 1 to 20 carbon atoms, composed of a combination of at least one of alkylene groups (preferably having 1 to 20 carbon atoms (referred to C-number hereinafter) such as methylene, ethylene, propylene, butylene, pentylene, hexylene, octylene, decylene, undecylene and —CH₂PhCH₂— (Ph represents a phenylene group) that may be substituted), alkenylene groups (preferably having a C-number of 2 to 20 such as ethenylene, propenylene and butadienylene groups), alkynylene groups (preferably having a C-number of 2 to 20 such as ethynylene, propynylene and butadinylene groups), cycloalkylene groups (preferably having a C-number of 3 to 20 such as 1,3-cyclopentylene and 1,4-cyclohexylene groups), arylene groups (preferably having a C-number of 6 to 26 such as 1,2-phenylene, 1,3-phenylene, 1,4-phenylene, 1,4-naphthylene and 2,6-naphthylene that may be substituted), heterylene groups (preferably having a C-number of 1 to 20 such as those prepared as divalent groups by eliminating two hydrogen atoms from pyrimidine, pyridine, triazine, piperazine, pyrrolidine, piperidine, pyrrole, imidazole, triazole, thiophene, furan, thiazole, oxazole, thiadiazole and oxadiazole that may be substituted), amide groups, ester groups, sulfamide groups, sulfonate ester groups, ureido groups, sulfonyl groups, sulfinyl groups, thioether groups, ether groups, imino groups and carbonyl groups.

The spacer group in the side chain L₁-P₁, containing a mesogenic unit preferably contains a methylene group, into which a divalent substituent may be inserted.

R₁ in formula (1) represents a hydrogen atom or a substituent. Preferable examples of the substituent include alkyl groups (preferably having 1 to 2 carbon atoms (referred to a C-number hereinafter) such as methyl, ethyl, n-propyl, isopropyl, n-butyl, n-pentyl, benzyl, 3-sulfopropyl, carboxymethyl, trifluoromethyl and chloromethyl groups that may be substituted), alkenyl groups (preferably having a C-number of 2 to 20 such as vinyl, allyl, 2-butenyl and 1,3-butadienyl groups), cycloalkyl groups (preferably having a C-number of 3 to 20 such as cyclopentyl and cyclohexyl groups), aryl groups (having a C-number of 6 to 20 such as phenyl, 2-chlorophenyl, 4-methoxyphenyl, 3-methylohenyl and 1-naphthyl groups, and biphenyl and terphenyl derivatives);
heterocyclic groups (preferably having a C-number of 1 to 20 such as pyridyl, pyrimidyl, thienyl, furyl, thiazoryl, imidazolyl, pyrazolyl, pyrrolidino, piperidino and morphorino groups), alkynyl groups (preferably having a C-number of 2 to 20 such as ethynyl, 2-propinyl, 1,3-butadinyl and 2-phenylrthynyl groups), halogen atoms (such as F, Cl, Br and I), amino groups (having a C-number of 0 to 20 such as amino, dimethylamino, diethylamino, dibutylamino and anilino groups), cyano group, nitro group, hydroxyl group, mercapto group, carboxyl group, sulfo group, phosphonic acid group, acyl groups (preferably having a C-number of 1 to 20 such as acetyl, benzoyl, salicyloyl and pyvaloyl groups), alkoxy groups (preferably having a C-number of 1 to 20 such as methoxy, butoxy and cyclohexyloxy groups), aryloxy groups (preferably having a C-number of 6 to 26 such as phenoxy and 1-naphthoxy groups), alkylthio groups (preferably having a C-number of 1 to 20 such as methylthio, ethylthio groups), arylthio groups (preferably having a C-number of 6 to 20 such as phenylthio and 4-chloroohenylthio groups), alkylsulfonyl groups (preferably with a C-number of 1 to 20 such as methanesulfonyl and butanesulfonyl groups);
arylsulfonyl groups (preferably having a C-number of 6 to 20 such as benzenesulfonyl and p-toluenesulfonyl groups), sulfamoyl groups (preferably having a C-number of 0 to 20 such as sulfamoyl, N-methyl sulfamoyl and N-phenyl sulfamoyl groups), carbamoyl groups (preferably having a C-number of 1 to 20 such as carbamoyl, N-methyl carbamoyl, N,N-dimethyl carbamoyl and N-phenyl carbamoyl groups), acylamino groups (preferably having a C-number of 1 to 20 such as acetylamino and benzoylamino groups), imino groups (preferably having a C-number of 2 to 20 such as phthalimino group), acetyloxy groups (preferably having a C-number of 1 to 20 such as acetyloxy and benzoyloxy groups), alkoxycarbonyl groups (preferably having a C-number of 2 to 20 such as methoxycarbonyl and phenoxycarbonyl groups), carbamoylamino groups (preferably having a C-number of 1 to 20 such as carbamoylamino, N-methylcarbamoylamino and N-phenylcarbamoylamino groups) and azo groups (preferably having a C-number of 1 to 20 such as phenylazo and naphthylazo groups). R₁ is more preferably a hydrogen atom, an alkyl group, an aryl group, a heterocyclic group, a halogen atom, an amino group, a cyano group, a nitro group, a hydroxyl group, a carboxyl group, an alkoxy group, an aryloxy group, an alkylsulfonyl groups, an arylsulfonyl group, a sulfamoyl group, a carbamoyl group, an acylamino group, an acyloxy group, an alkoxycarbonyl group and an azo group.

It is also preferable that R₁ contains one or plural divalent linking groups raised as examples for L₁.

The spacer group in the side chain R₁ containing the mesogenic unit preferably contains methylene chains that may be separated by divalent substituents. The mesogenic unit contained in R₁ is preferably a non-photoresponsive group, and the mesogenic unit is preferably a liner mesogenic unit used for conventional low molecular weight liquid crystals such as biphenyl-base groups containing p-substituted aromatic rings, terphenyl-base groups, benzoate ester-base groups, cyclohexyl carboxylate ester-base groups, phenyl cyclohexane-base groups, pyrimidine-base groups, dioxane-base groups and cyclohexyl cyclohexane-base groups.

P₁ in formula (1) represents a group containing photoresponsive group site. The photoresponsive group site of the invention is preferably a portion of a compound capable of structural changes by absorbing light. The absorbed light is preferably a UV light, visible light or IR light with a wavelength of 200 to 1000 nm, and a UV or visible light with a wavelength of 200 to 700 nm is more preferable.

The photoresponsive group site in the invention preferably has an anisotropic (dichroic) molar absorptivity and an anisotropic refractive index (specific birefrigence index).

P₁ as the photoresponsive group site preferably comprises any one of the skeletons of azobenzene, stilbene, azomethine, stilbazolium, cinnamic acid (cinnamate ester), chalcone, spirolane, spirodioxane, diarylethene, fulgide, fulgidimide, thioindigo and indigo skeletons, more preferably comprises any one of the skeletons of azobenzene, spirolane, diarylethene, fulgide and fulgidimide skeletons, and most preferably comprises the azobenzene skeleton.

P₁ is preferably represented by —Ar₁—N═N—Ar₂ when P₁ is a group comprising the azobenzene skeleton. Ar₂ represents an aryl group (preferably with a C-number of 6 to 26 such as phenyl, 1-naphthyl and 2-naphthyl groups) or heterocyclic groups (preferably having a C-number of 1 to 26 such as pyridyl, pyrimidyl, pyrazyl, triazyl, pyrrolyl, imidazolyl, triazolyl, oxazolyl, thiazolyl, pyrazolyl, thienyl, furyl, isothiazolyl, oxadiazolyl, thiadiazolyl and isooxazolyl groups).

The aryl group or heterocyclic group may be substituted, and the preferable substituents include the examples R₁ mentioned in the above. The preferable examples thereof include a condensed benzene ring, a naphthalene ring, a pyridine ring, a cyclohexene ring, a cyclopentene ring, a thiophene ring, a furan ring, an imidazole ring, a thiazole ring, an isothiazole ring and an oxazole ring. Most preferable examples thereof include a condensed benzene ring.

In the following are listed preferable examples of the heterocyclic groups when Ar₂ is a heterocyclic group. However, the invention is not limited thereto. The bond extending from the ring shows the substitution site of the azo group.

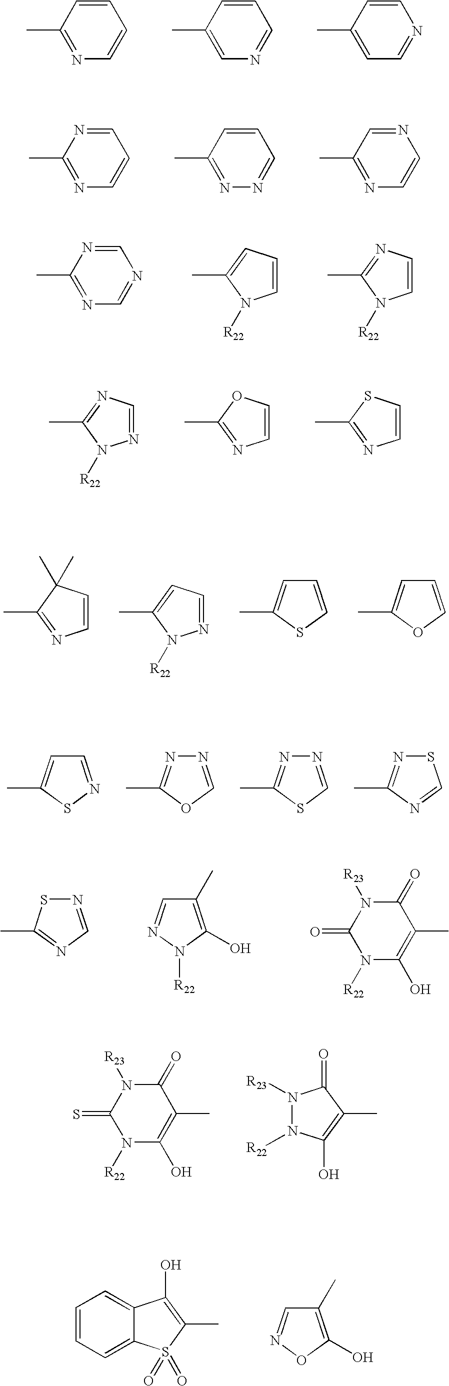

R₂₂ and R₂₃ in the formulae each independently represent a hydrogen atom, an alkyl group, an alkenyl group, a cycloalkyl group, an aryl group and a heterocyclic group (examples of the preferable substituent are the same as those listed for R₁). The hydrogen atom on the heterocyclic ring may be substituted, and examples of the preferable substituent include those listed for R₁.

Ar₁ represents an arylene group or a heterylene group. This group is preferably a divalent group prepared by eliminating an additional hydrogen atom from the aryl group or a heterocyclic group as preferable examples of Ar₂.

Ar₁ is preferably a 1,4-phenylene group that may be substituted when it is the arylene group. Ar₁ is more preferably an arylene group.

While the photoresponsive group may also serve as the mesogenic unit in the invention, examples of the photoresponsive group that may serve as the mesogenic unit include azobenzene, stilbene and azomethine.

The photoresponsive group is contained in the optical recording material preferably in an amount of approximately 20% by mass or less, and more preferably in an amount of approximately 10% by mass or less based on the mass of the optical recording material. Absorption of the recording light increases to make effective optical recording difficult when the content of the photoresponsive group exceeds 20% by mass. The lower limit of the content is preferably about 0.00001% by mass.

In formula (1), al is in the range of 0.0001 to 1, and more preferably in the range of 0.0001 to 0.5, while a2 is in the range of 0 to 0.9999, and more preferably in the range of 0.5 to 0.999. n1 represents an integer in the range of 4 to 2000, and more preferably in the range of 10 to 2000.

A₁ and A₂ in formula (1) each independently represent any one of the following groups represented by formulae (2-1) to (2-4).

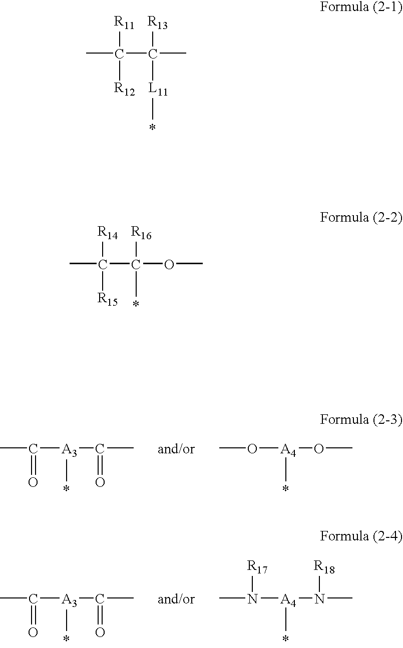

Each of the structures represented by formulae (2-1) to (2-4) is linked to L₁ or R₁ at the site represented by a mark (*). R₁₁ to R₁₃ in formula (2-1) each independently represent a hydrogen atom or a substituent, and L₁₁ represents one selected from the group consisting of —O—, —OC(O)—, —CONR₁₉—, —COO— (the left side of each being linked to the polymer main chain, and the right side of each being linked to L₁ or R₁) and a substituted or unsubstituted arylene group. R₁₉ represents one selected from the group consisting of a hydrogen atom, an alkyl group, an alkenyl group, a cycloalkyl group, an aryl group and a heterocyclic group. R₁₄ to R₁₆ in formula (2-2) each independently represent a hydrogen atom or a substituent. A₃ and A₄ in formulae (2-3) and (2-4) each independently represent a trivalent linking group. R₁₇ and R₁₈ in formula (2-4) each independently represent one selected from the group consisting of a hydrogen atom, an alkyl group, an alkenyl group, a cycloalkyl group, an aryl group and a heterocyclic group.

R₁₁ to R₁₃ in formula (2-1) each independently represent a hydrogen atom or a substituent, more preferably represent a hydrogen atom, an alkyl group, an aryl group and a cyano group, more preferably represent a hydrogen atom or methyl group, and further preferably represent a hydrogen atom.

In formula (2-1), L₁₁ represents —O—, —OC(O)—, —CONR₁₉—, —COO— (the left side of each being linked to a polymer main chain, and the right side of each being linked to L₁ or R₁), an arylene group that may be substituted (preferably having a C-number of 6 to 26 such as 1,2-phenylene, 1,3-phenylene, 1,4-phenylene, 1,4-naphthylene and 2,6-naphthylene groups that may be substituted). R₁₉ represents a hydrogen atom, an alkyl group, an alkenyl group, a cycloalkyl group, an aryl group and a heterocyclic group (examples of the preferable substituents are the same as those listed as examples for R₁), and preferably represents a hydrogen atom or an alkyl group.

R₁₄ to R₁₆ in formula (2-2) each independently represent a hydrogen atom or a substituent, preferably represent a hydrogen atom or an alkyl group, and more preferably represent a hydrogen atom or a methyl group.

A₃ and A₄ in formulae (2-3) and (2-4) each independently represent a trivalent linking group. Preferable examples of A₃ and A₄ include as follows:

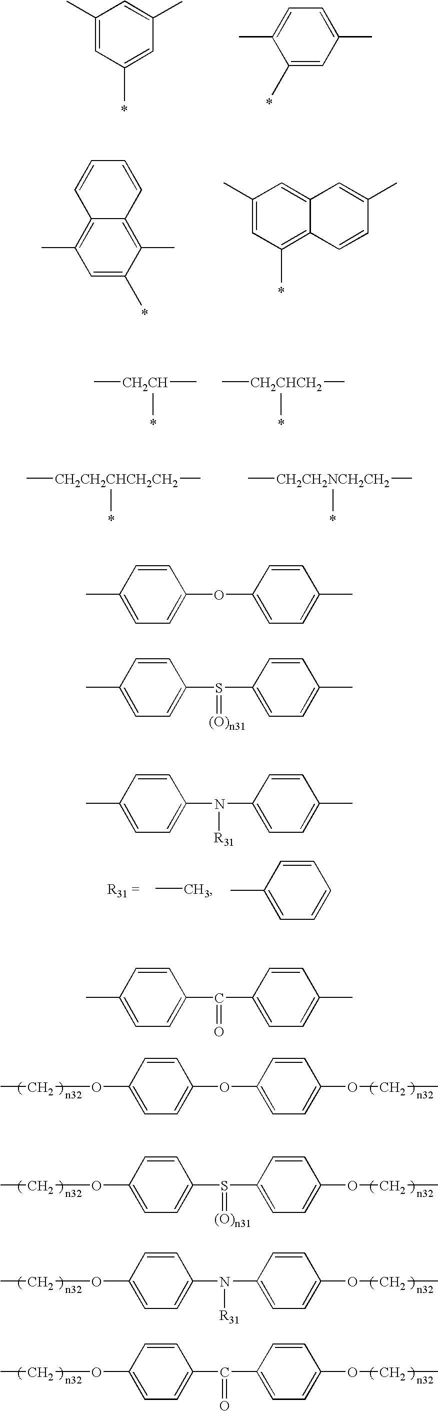

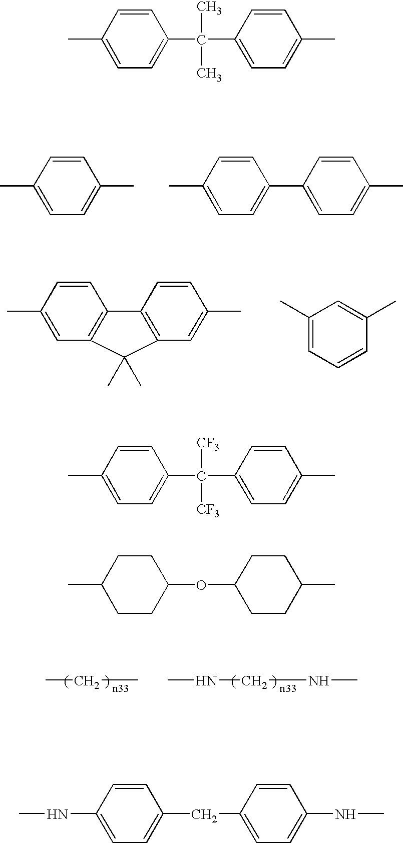

In these formulae, n31 represents an integer of 0 to 2, n32 represents an integer of 2 to 12, n33 represents an integer of 2 to 12, and n34 represents an integer of 2 to 8.

In formula (2-4), R₁₇ and R₁₈ each independently represent a hydrogen atom, an alkyl group, an alkenyl group, a cycloalkyl group, an aryl group and a heterocyclic group (examples of the preferable substituent are the same as examples raised for R₁).

A₁ and A₂ preferably represent formula (2-1) or (2-3), and more preferably formula (2-3).

The structure of the main chain of the polymer or oligomer containing the photoresponsive group site is not particularly limited in the invention. However, when the main chain contains an organic group having a cyclic structure, the photoresponsive group and/or the mesogenic unit is preferably contained in the side chain, and all or a part of the side chains are preferably linked to all or a part of the organic groups having a cyclic structure.

By taking the above-described structure, it may become possible to suppress the formation of a liquid crystal phase that may cause scattering noises in the thick film medium.

The polymer or oligomer represented by formula (1) having a main chain comprising an organic group having a cyclic structure is more preferably represented by the following formula (3):

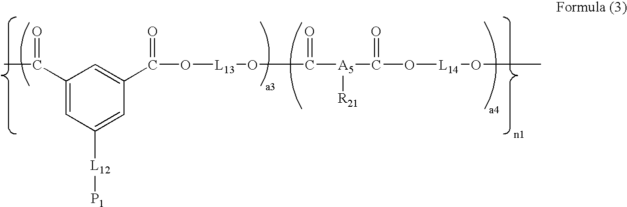

P₁ and n1 in formula (3) are defined as the same as those in formula (1).

In formula (3), R₂₁ represents a hydrogen atom or a substituent (examples of the preferable substituent are the same as those listed as examples for R₁), and more preferably represents one selected from the group consisting of a hydrogen atom, an alkyl group, an aryl group, a heterocyclic group, a halogen atom, an amino group, a cyano group, a nitro group, a hydroxyl group, a carboxyl group, an alkoxy group, an aryloxy group, an alkyl sulfonyl group, an aryl sulfonyl group, a sulfamoyl group, a carbamoyl group, an acylamino group, an acyloxy group and an alkoxycarbonyl group.

R₂₁ preferably contains one or plural divalent linking groups listed as examples for L₁.

L₁₂ represents a divalent linking group, and the preferable examples thereof are the same as those listed as examples for L₁ in formula (1). L₁₃ and L₁₄ each independently represent a divalent linking group, A₅ represents a trivalent linking group, and preferable examples thereof are the same as those listed as examples for A₄.

a3 is preferably in the range of 0.0001 to 1, and more preferably in the range of 0.001 to 0.999; and a4 is preferably in the range of 0 to 0.9999, and more preferably in the range of 0.001 to 0.999.

The polyester represented by the following formula (4) is particularly preferable as the polymer or oligomer having the structure represented by formula (3) of the invention:

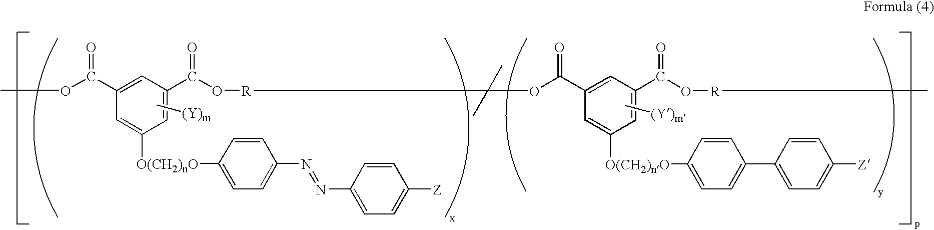

In formula (4), Y and Y′ each independently represent a hydrogen atom or a lower alkyl group. Z and Z′ each independently represent a hydrogen atom, a methyl group, a methoxy group, a cyano group and a nitro group. R represents a substituted or non-substituted aromatic or aliphatic group, or a hydrocarbon chain containing these groups. m and m′ each independently represent an integer of 1 to 3. n and n′ each independently represent an integer of 2 to 18 (n and n′ are not the same with each other). p represents an integer of 5 to 2000. x and y each represents the abundance ratio of a repeating unit satisfying the relation of 0<x≦1 and 0≦y<1, and x+y=1.

n and n′ are preferably in the range where the methylene group as the spacer group is related as described above. That is, in the polyester represented by formula (4), it is particularly preferable, in view of obtaining high sensitivity and wide dynamic range, to design so that n is in the range of 2 to 12 and n′ is in the range of 4 to 20, and particularly preferably n is in the range of 2 to 4 and n′ is in the range of 4 to 8.

The polyester represented by formula (4) is obtained by allowing the dicarboxylic acid monomer represented by the following formula (5) to react with the photoresponsive dicarboxylic acid monomer represented by the following formula (6) and the diol compound represented by the following formula (7) in the presence of an appropriate catalyst.

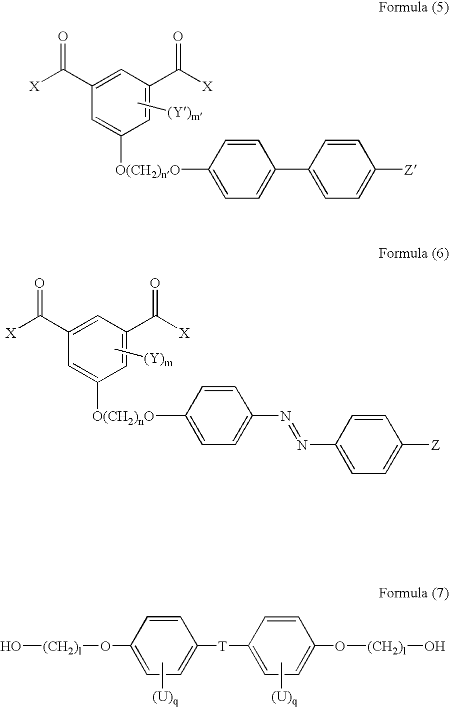

In formula (7), U represents a hydrogen atom, a halogen atom, a substituted or non-substituted lower alkyl group, a substituted or non-substituted lower alkenyl group, or a substituted or non-substituted lower alkynyl group. T represents a sulfone bond, sulfoxide bond, ether bond, thioether bond, substituted imino bond or ketone bond. q represents an integer of 1 to 4, while 1 represents an integer of 2 to 18.

The polymer or oligomer containing the photoresponsive group site of the invention preferably has a number average molecular weight in the range of 1000 to 10,000,000, and more preferably in the range of 10,000 to 1,000,000.

While specific examples of the polymer or oligomer containing the photoresponsive group site represented by formula (1) are shown below, the invention is by no means restricted to these examples.

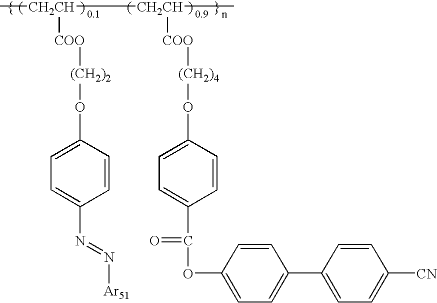

| | Ar₅₁ |
|---|---|
| P-28 | 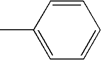 |
| P-29 | 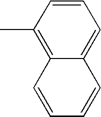 |
| P-30 | 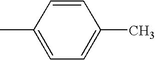 |
| P-31 | 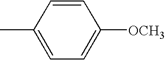 |
| P-32 | 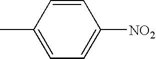 |
| P-33 | 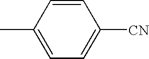 |
| P-34 | 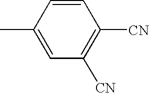 |
| P-35 | 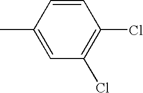 |
| P-36 | 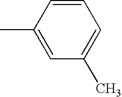 |
| P-37 | 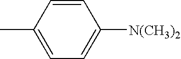 |
| P-38 | 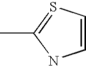 |
| P-39 | 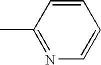 |
| P-40 | 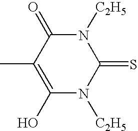 |
| P-41 | 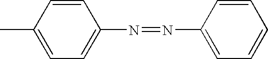 |

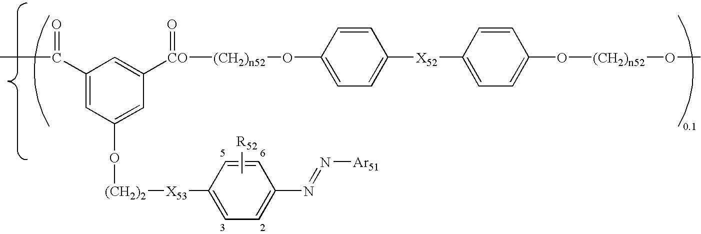

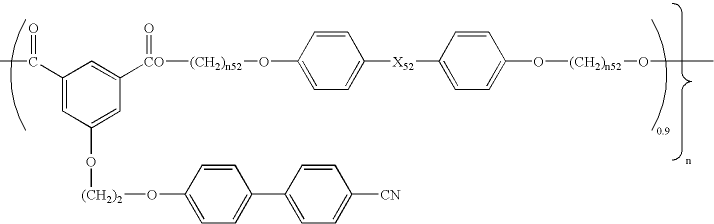

| | Ar₅₁ | R₅₂ | X₅₃ | X₅₂ | n₅₂ |
|---|---|---|---|---|---|
| P-66 | 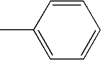 | H | —O— | —O— | 6 |
| P-67 | 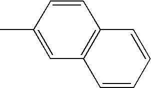 | H | —O— | —O— | 6 |
| P-68 | 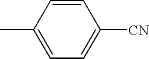 | H | —O— | —O— | 6 |
| P-69 | 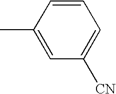 | 3-Cl | —O— | 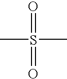 | 8 |
| P-70 | 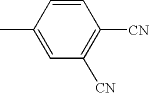 | 3-COOCH₃ | —O— | 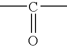 | 6 |
| P-71 | 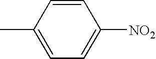 | H | —O— | —O— | 6 |
| P-72 | 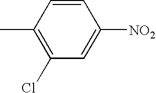 | H | —O— | —O— | 8 |
| P-73 | 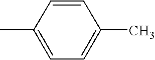 | H | —O— | —O— | 6 |
| P-74 | 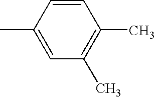 | H | 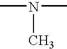 | 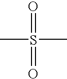 | 8 |
| P-75 | 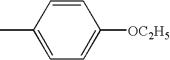 | H | —O— | —O— | 6 |
| P-76 | 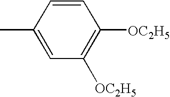 | H | 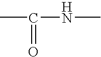 | 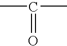 | 6 |
| P-77 | 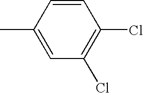 | 2-CH₃ | —O— | —O— | 8 |
| P-78 | 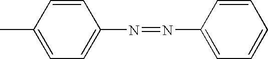 | H | —O— | 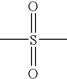 | 6 |
| P-79 | 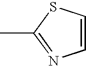 | 2-OCH₃ | —O— | —O— | 6 |
| P-80 | 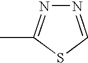 | H | —O— | 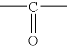 | 8 |
| P-81 | 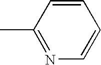 | H | —O— | 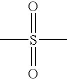 | 6 |
| P-82 | 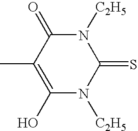 | H | —O— | —O— | 6 |
| P-83 | 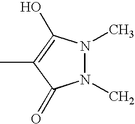 | 2-OCH₃ | —O— | —O— | 6 |

The polymers or oligomers listed above can be synthesized by the known methods disclosed in JP-A Nos. 2001-294652, 2000-264962 and 10-212324, Japanese National Publication Nos. 2000-514468 and 2002-539476, and U.S. Pat. No. 6,441,113 B1, the disclosures of which are incorporated by reference herein.

<Optical Recording Medium>

(Structure of Optical Recording Medium)

The optical recording medium of the invention comprises a photosensitive layer comprising the optical recording material of the invention.

The optical recording medium of the invention may comprise a substrate and the photosensitive layer comprising the optical recording material, or may comprise the optical recording material in which the entire optical recording medium is the photosensitive layer. While the substrate is not particularly restricted so long as it is transparent and fast in the wavelength region to be used, and does not show remarkable deterioration and dimensional changes in ambient temperature and humidity regions, examples of them include soda glass, borosilicate glass, potassium glass, acrylic resin plate, polycarbonate sheet and polyethylene terephthalate (PET) sheet.

The optical recording medium of the invention has enabled to thicken the photosensitive layer that had been difficult to prepare by the conventional art by using the optical recording material described above. The thickness of the photosensitive layer can be changed in the range of 20 μm to 10 mm without impairing optical recording property. While multiplicity of recording can be improved as the thickness of the photosensitive layer is larger, the diffraction efficiency of the multiple hologram decreases in approximately inverse proportion to the square of multiplicity. Accordingly, the favorable thickness is in the range capable of several thousands of multiplicity, or in the range of 50 to 1000 μm.

It is preferable in the recording medium of the invention that the abundance ratio of the side chains, in which at least two kinds of spacers having lengths different from each other are introduced in the polymer or oligomer comprising the photoresponsive group site, changes in the thickness direction of the film.

In other words, changing the abundance ratio in the thickness direction of the film from the surface of the optical recording medium permits optical sensitivity to be controlled in the depth direction of the optical recording medium.

It is particularly preferable in the invention that the abundance ratio of the side chain, in which short spacer groups are introduced in the polymer or oligomer comprising the photoresponsive group, increases in the direction of advance of the recording light. While the intensity of the recording light is attenuated by absorption of the medium as the light advances, sensitivity to the light increases in the direction of advance of the light by increasing the abundance ratio of the side chains, in which short spacers are introduced, in the depth direction. Accordingly, the refractive index amplitude of the hologram formed is suppressed from being attenuated, or reproduction of data with a high S/N ratio is possible by suppressing angle selectivity based on the Bragg's condition from being deteriorated.

The abundance ratio of the side chains, in which the short spacers are introduced in the range of 50 to 100 μm in the direction of advance of the recording light from the surface of the optical recording medium, preferably changes in the range of from about 0 to 20% by mole to about 50 to 100% by mole relative to the total amount of the side chains.

The transmittance or reflectance of the optical recording medium in the wavelength region used in the invention is preferably in the range of 40 to 80%, and more preferably in the range of 50 to 70%. Obtaining high diffraction efficiency may be difficult due to absorption loss when the transmittance or reflectance is less than 40%, while realizing high sensitivity may be difficult due to the decrease in the amount of dyes when the transmittance or reflectance exceeds 80%.

The optical recording medium of the invention can be formed into a two-dimensional or three-dimensional shape such as a sheet, tape, film and disk. Specifically, a transparent and tough film of the optical recording medium can be formed by dissolving the optical recording material in an aliphatic or aromatic halogenated or ether solvents such as chloroform, methylene chloride, o-dichlorobenzene, tetrahydrofuran, anisole and acetophenone followed by applying the solution on a substrate such as a glass. The optical recording material may be also formed into a film by heat-compression of a solid of the optical recording material such as a powder, pellet or flake by a hot-press method.

The favorable optical recording medium of the invention is as follows: (1) an optical recording medium having a disk shape capable of recording/reproducing by allowing a recording/reproducing head to scan on the rotating radius of the disk by rotating the disk; (2) an optical recording medium in a sheet shape capable of recording/reproducing by allowing a recording/reproducing head to scan in the two-dimensional direction; (3) an optical recording medium in a tape shape capable of recording/reproducing by allowing a recording/reproducing head to scan on a given portion of the tape while the tape is reeled; (4) an optical recording medium in a three-dimensional bulk shape which is secured on a fixed or movable stage capable of recording/reproducing by allowing a movable or fixed recording/reproducing head to scan on the surface or inside of the bulk of the recording medium; and (5) an optical recording medium formed into a two-dimensional or three-dimensional shape such as a disk, sheet or card by appropriately laminating the films of the recording medium, which is able to record/reproduce by allowing a recording/reproducing head to scan by the any one of the methods according to (1) to (4), or by a combination of these methods.

(Applicable Recording Method)

The optical recording medium of the invention is used for optical recording taking advantage of the change in absorption, refractive index or shape of the optical recording material caused by irradiating light to or by heating the optical recording material.

Examples of the optical recording method include hologram recording, absorption modulation recording, reflective index modulation recording and light-induced relief forming methods. The hologram recording method is the suitable optical recording method for the optical recording medium of the invention. The optical recording medium of the invention is able to independently record when the polarization directions of light incident to the medium and reference light are parallel with one another and when the polarization directions are perpendicular to one another. The disposition of polarization in hologram recording is not restricted by the polarization directions, and any dispositions may be selected so long as they are able to form light intensity distribution or polarized light distribution by interference. The hologram recording may be performed by the amplitude, phase and polarization direction of the incident light.

<Optical Recording/Reproducing Apparatus>

The invention provides an optical recording/reproducing apparatus for recording/reproducing of information using the optical recording medium of the invention.

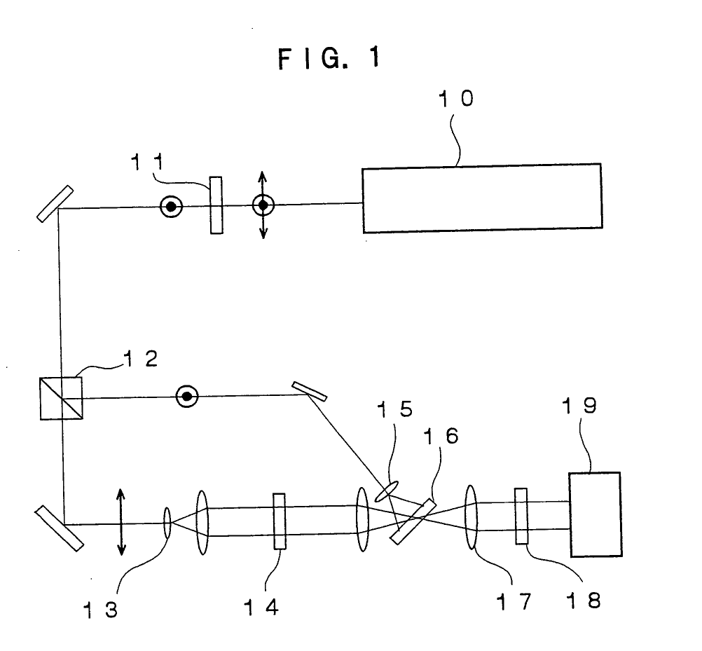

FIG. 1 shows an example of the optical recording/reproducing apparatus of the invention.

An oscillation beam of 532 nm of a solid laser excited with a laser diode is used in the invention. The laser beam emitted from the solid laser 10 (Nd:YVO₄) impinges a polarized beam splitter 12 through a ½ wavelength plate 11, and is divided into signal light and reference light with the polarized beam splitter 12. The signal light is magnified and collimated with a lens system 13, and passes through a spatial light modulator (liquid display element) 14. Data encoded depending on information is expressed as brightness and darkness of the liquid crystal display as the spatial light modulator 14, and loaded to the signal light. Then, the signal light is Fourier-transformed with the lens and is irradiated into an optical recording medium (a polyester film) 16. The reference light is transformed into a spherical wave with a lens 15 placed immediately before the optical recording medium 16, and is irradiated so as to overlap the signal light in the optical recording medium 16. Information loaded on the signal light as described above can be recorded as a hologram in the optical recording medium. The reference numerals 18 and 19 in FIG. 1 represent a polarization plate and a CCD camera, respectively.

It has been described above that three-dimensional multiple recording is possible by taking advantage of selectivity of the hologram selectivity depending on the incident light angle of the reference light in a thick hologram. Recording using the spherical reference light, and allowing a recorded medium to move in a plane direction correspond to changing the incident angle of the reference light to the substantially recorded hologram. Accordingly, three-dimensional multiple recording is readily achieved by the shift of the optical recording medium 16 while the optical paths of the signal light and reference light are fixed. While the multiple recording method by the shift of the spherical reference light is shown in this example, the multiple recording method is not restricted thereto, and various multiple methods such as angle multiple, polarization angle multiple, correlation multiple and wavelength multiple methods may be used.

A light source emitting a coherent light sensitive to the recording layer (photosensitive layer) of the optical recording medium 16 may be used. A solid laser excited by a laser diode with an oscillation wavelength of 532 nm or an argon ion laser with an oscillation wavelength of 515 nm, which correspond to the foot of the absorption peak of the optical recording medium 16, may be used as the light source used for the recording layer of the optical recording material of the invention.

A transmittance type spatial light modulator prepared by forming transparent electrodes on both surfaces of an electrooptical modulation material such as a liquid crystal may be used as the spatial light modulator 14. A liquid crystal panel for a projector is an example of the spatial light modulator of this type.

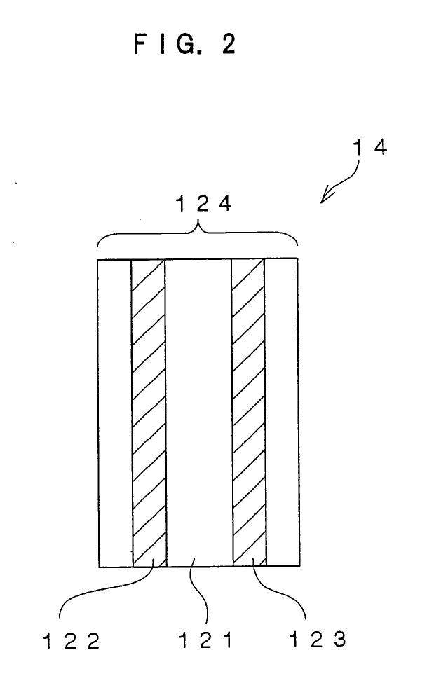

At least the polarizer plate disposed at the output side should be removed for enabling polarized light modulation when the liquid crystal panel for the projector is used. For example, the spatial light modulator 14 may be composed of a transmittance type liquid crystal cell 124 having the electrodes 122 and 123 formed on both surfaces of a liquid crystal 121 as an electrooptical conversion member as shown in FIG. 2. Plural two-dimensional pixels are formed in the spatial light modulator for polarization modulation, and each pixel is made to function as the ½ wavelength plate. Polarization of light impinging each pixel is modulated by applying bit information corresponding to a two-dimensional data to each pixel as binary data (0 or 1) of applied voltage. Using such spatial light modulator 14 enables information to be recorded by polarization modulation of the signal light encoded by the polarization direction of light.

The data are reproduced by irradiating the reference light only on the optical recording medium 16. The light diffracted from the spherical reference light wave is Fourier-transformed with the lens 17, and an arbitrary polarized angle component is selected with the polarizer 18 to focus the component on the CCD camera 19. The intensity distribution reproduced with the CCD camera 19 is divided into binary data by setting an arbitrary threshold level, and recorded information is reproduced by decoding by an appropriate method.

The recording apparatus and reproducing apparatus may be integrated as shown in FIG. 1, or they may be constructed as different units. The wavelength of the light source may be the same as that of the recording wavelength, or a helium-neon laser having an oscillation wavelength of 633 nm, for example, that is not sensitive to (or is not absorbed by) the recording layer may be used as the light source. This enables non-destructive reading of recorded information.

As hitherto described, the invention provides a thick film medium with high sensitivity that realizes high diffraction efficiency using the optical recording medium of the invention. Accordingly, multiplicity of three dimensional hologram recording is largely improved to enable the optical recording material to be used as a large capacity optical recording medium. The optical recording medium of the invention is also possible to record the polarization direction of the signal light to thereby enable the recording medium to be used as a medium for large capacity recording methods and optical processing methods taking advantage of polarized light recording. The invention also provides a large storage capacity recording/reproducing apparatus using the optical recording medium.

### EXAMPLES

The present invention will be described in detail below with reference to examples. However, the following examples should not be construed to limit the scope of the invention.

<Hologram Recording Property>

An optical recording material of the invention having spacers of the photoresponsive side chains shorter than spacers of the non-photoresponsive side chains is synthesized, and the optical recording material is compared with conventional optical recording materials in the optical recording medium and in the optical recording/reproducing apparatus using the optical recording medium.

(Synthesis of Photoresponsive Polyester)

—Photoresponsive Polyester 1 (Optical Recording Material of the Invention)—

Mixed in a 300 ml three-necked flask equipped with a vacuum evacuator and stirrer are 0.003 mol of diethyl 5{6-[4-(4-methylphenylazo)phenoxy]butyloxy}isophthalate (photoresponsive dicarboxylic acid monomer carrying methylazobenzene), 0.007 mol of diethyl 5-{6-[4-(4-cyanophenyl)phenoxy]hexyloxy}isophthalate (dicarboxylic acid monomer carrying cyanobiphenyl), 0.001 mol of 6,6′-(4,4′-sulfonyldiphenylenedioxy)dihexanol, 0.009 mol of 6,6′-(4,4′-oxydiphenylenedioxy)dihexanol and 0.1 g of zinc acetic anhydride, and the mixture is allowed to react at 160° C. for 2 hours with stirring and heating in a nitrogen atmosphere, and under a pressure of about 1.3×10³ Pa for 20 minutes.

Then, the temperature of the reaction system is raised to 180° C. while the pressure is gradually reduced to 2.7×10² Pa in 30 minutes. The reaction product is dissolved in chloroform after completing the reaction, and the solution is poured into methanol to harvest a crude polymer by re-precipitation. The crude polymer is re-precipitated followed by washing with hot methanol and boiling water to obtain the desired photoresponsive polyester after filtration and drying in vacuum. The yield is 69.6% (6.400 g), and the polyester has a number average molecular weight of 9,705.

The structural formula of this photoresponsive polyester 1 (XO6SO6YCH4CB6) is shown below. The blocks represented by the parentheses are copolymerized with each other in the following structural formula, and x and y represent the composition ratios of the blocks containing azobenzene and cyanobiphenyl, respectively, while x′ and y′ represent the composition ratios of the blocks not containing them, respectively. These definitions may apply to the following formulae as well. 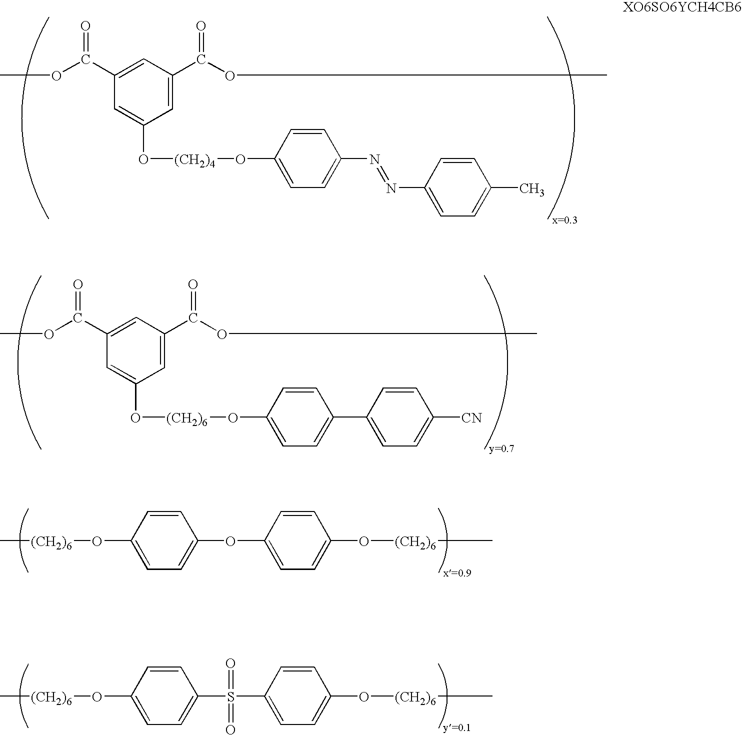
—Photoresponsive Polyester 2—

Photoresponsive polyester 2 having the same length of spacers of the side chains is obtained by the same method as synthesizing photoresponsive polyester 1, except that 0.007 mol of diethyl 5-{6-[4-(4-cyanophenyl)phenoxy]butyloxy}-isophthalate is used in place of 0.007 mol of diethyl 5-{6-[4-(4-cyanophenyl)phenoxy]hexyloxy}isophthalate used in the synthesis of photoresponsive polyester 1. The yield is 75.0% (6.842 g), and the number average molecular weight is 9,568.

The structural formula of photoresponsive polyester 2 (XO6SO6YCH4CB4) is shown below. 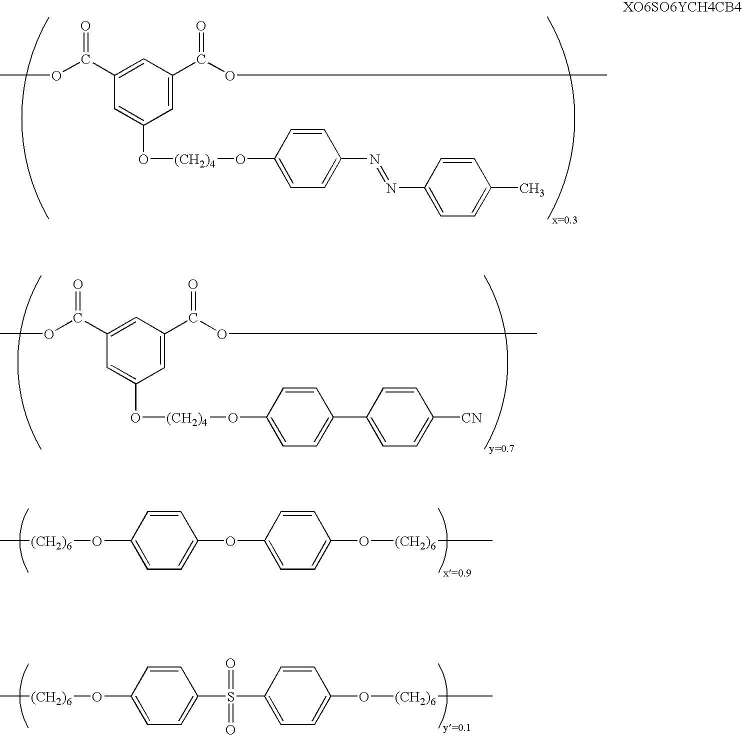
(Preparation of Sandwich Type Glass Cell Medium (Optical Recording Medium))

Flakes of photoresponsive polyester 1 are placed on a cleaned glass substrate, and another glass substrate is placed thereon. A sandwich type glass cell medium having photoresponsive polyester 1 sandwiched with two sheets of the glass substrate is prepared by press-heating in vacuum. The thickness of the optical recording material layer is controlled to 250 μm by using a spacer having the same thickness as the thickness of the optical recording layer. A transparent and uniform film exhibiting no scattering and containing no air bubbles in the optical recording material layer is obtained by heating and quenching the glass cell medium prepared. The glass cell medium obtained is used as optical recording medium A (the optical recording medium of the invention). Optical recording medium B is also obtained using photoresponsive polyester 2 as the optical recording material layer.

The transmittance of optical recording medium A using photoresponsive polyester 1 for the optical recording material layer is measured using laser light with a wavelength of 532 nm. The results show that the transmittance is 54.4%. The transmittance of optical recording medium B is also measured by the same method, and obtained a transmittance of 54.1%.

(Hologram Recording Property of Optical Recording Medium)

Hologram is recorded using optical recording media A and B in order to compare recording/reproducing property between the optical recording medium of the invention and conventional optical recording medium.

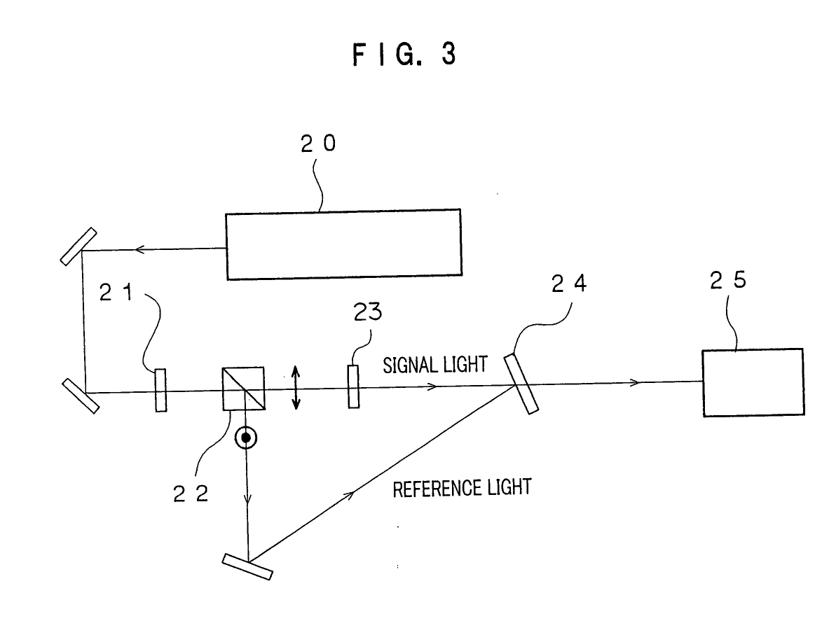

The optical system (optical recording/reproducing apparatus) used for hologram recording above is shown in FIG. 3. An oscillation beam with a wavelength of 532 nm from a solid laser 20 excited by a laser diode is used for recording/reproducing. The linear polarized light emitted from the solid laser (Nd:YVO₄) 20 is split into signal light and reference light with a polarized beam splitter 22 after rotating the polarized light with a ½ wavelength plate 21. The intensity balance between the two light beams can be adjusted by controlling the rotation angle of the polarized light. These two light beams are crossed in the optical recording medium (polyester film) 24, and optical anisotropy is induced in the medium depending on the intensity distribution or polarized light distribution caused by interference of two light beams. The ½ wavelength plate 23 in the signal light path controls polarization of the signal light to thereby enable an intensity-modulated hologram, which has parallel polarization directions between the signal light and reference light, or a polarization-modulated hologram having a perpendicular polarization directions between the signal light and reference light to be recorded.

Diffraction light due to the recorded hologram is obtained by irradiating only the reference light to the optical recording medium 24 for reproduction, and the output light intensity is measured with a power meter 25. The diffraction efficiency of the optical recording medium 24 is calculated by determining the ratio of the intensity of the reference light to the intensity of the diffraction light.

The holograms are recorded using optical recording media A and B using the optical system described above. It is found that recording of the intensity-modulated hologram in which the polarization directions of the signal light and reference light are parallel to one another, and recording of the polarization-modulated hologram in which the polarization directions of the signal light and reference light are perpendicular to one another, are possible.

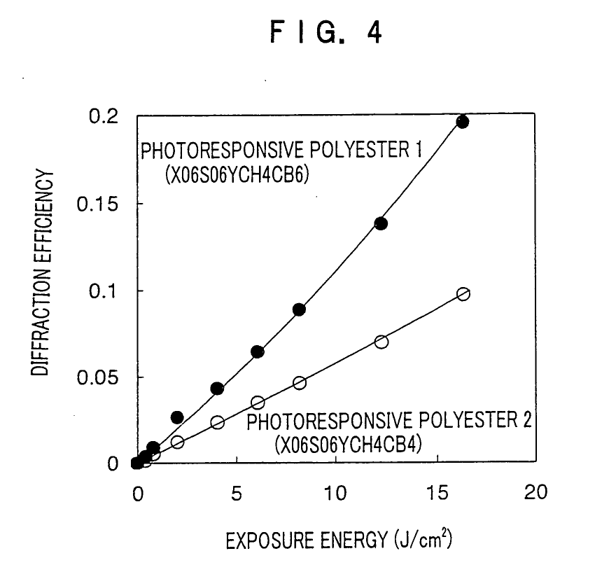

FIG. 4 is a graph illustrating the plots of the diffraction efficiency of the polarization-modulated hologram against the exposed light energy with respect to optical recording media A and B. FIG. 4 shows that a sensitivity approximately twice as high as that of optical recording medium B is achieved by using optical recording medium A as the optical recording medium of the invention as determined by the slope the graph. The maximum diffraction efficiency exceeds 25%. These data show that a medium having a thickness of 250 μm that realizes high sensitivity and high diffraction efficiency can be prepared.

Digital data are recorded on and reproduced from optical recording media A and B using the optical recording/reproducing apparatus shown in FIG. 1. Specifically, 162 KB digital data are divided into 20 data pages using 800×600 pixels of the spatial light modulator 14 as 1 page and are used for multiple recording. The recorded data can be reproduced by decoding reproduced two-dimensional data pages.

Since the bit error rate on optical recording medium A is not larger than 1×10⁻³, these errors are correctable using known methods. The recording energy necessary for recording on optical recording medium A is about 50% of that for recording on optical recording medium B. These results show that a large amount of energy may be saved in the optical recording medium of the invention as compared with conventional optical recording media.

<Birefringent Recording Property Due to Irradiation of Linearly Polarized Light>

Information is recorded on the optical recording medium by birefringent recording due to irradiation of linearly polarized light, and the optical recording material of the invention is compared with conventional optical recording materials using an optical recording material prepared by blending two kinds of photoresponsive polymers containing spacers having lengths different from each other.

(Preparation of Optical Recording Material)

—Synthesis of Photoresponsive Polyester—

Two kinds of photoresponsive polyester having different lengths of spacer at the side chains are synthesized by the same method and procedure described in the synthesis of photoresponsive polyester in the above-mentioned hologram recording property. Specifically, diethyl 5-{6-[4-(4-cyanophenylazo)phenoxy]butyloxy}isophthalate as a photoresponsive carboxylic acid monomer as a side chain carrying cyanobenzene, and 6,6′-(4,4′-oxydiphentlenedioxy)dihexanol as a main chain monomer are allowed to react in an equal quantity (equimolar ratio) to obtain photoresponsive polyester 3 with a number average molecular weight of 12,208. Also, diethyl 5-{6-[4-(4-cyanophenylazo)phenoxy]hexyloxy}isophthalate as a side chain and 6,6′-(4,4′-oxydiphenylenedioxy)dihexanol are allowed to react in an equal quantity (equimolar ratio) to obtain photoresponsive polyester 4 with a number average molecular weight of 13,350.

The structural formulae of photoresponsive polyester 3 (XO6YCN4) having the shorter spacer in the side chain and photoresponsive polyester 4 (XO6YCN6) having the longer spacer in the side chain are shown below. 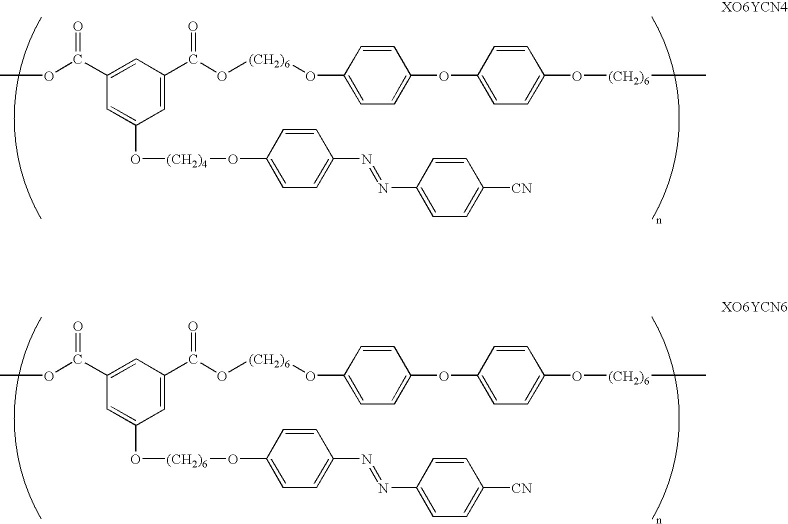
—Preparation of Optical Recording Material—

Photoresponsive polyesters 3 and 4 alone, as well as a mixture of these polymers of two kinds of photoresponsive polyester having different lengths of spacers at the side chains are used as the optical recording materials. These materials are three kinds of polymer blends (optical recording materials of the invention) with mixing ratios of photoresponsive polymers 3 and 4 of 0.25, 0.50 and 0.75, respectively. The polymers are mixed by dissolving them together in a solvent when a solution for preparing the following optical recording medium is prepared.

(Preparation of Optical Recording Medium)

Optical recording media are prepared using two kinds of homopolymers (photoresponsive polyesters 3 and 4) and three kinds of polymer blends. Each of these optical recording materials is dissolved in chloroform at a concentration of 0.1 g/ml, and each solution is spin-coated on a clean glass substrate at a rotation speed of 1,000 rpm for 10 seconds. After drying, the thickness of each film is measured to be as thin as 1.5 to 2 μm by using a needle-probe-type surface roughness meter. The surface is smooth, and a transparent amorphous film without scattering is obtained by quenching after heating.

The optical recording media using photoresponsive polyesters 3 and 4 as the optical recording layer obtained above are used as optical recording media C and D, respectively. Recording media using three kinds of polymer blends having mixing ratio of light responsive polyester 3 to light responsive polyester 4 of 0.25, 0.50 and 0.75 are used as optical recording media E, F and G, respectively.

(Birefringent Recording Property of Optical Recording Medium Due to Irradiation of Linearly Polarized Light)

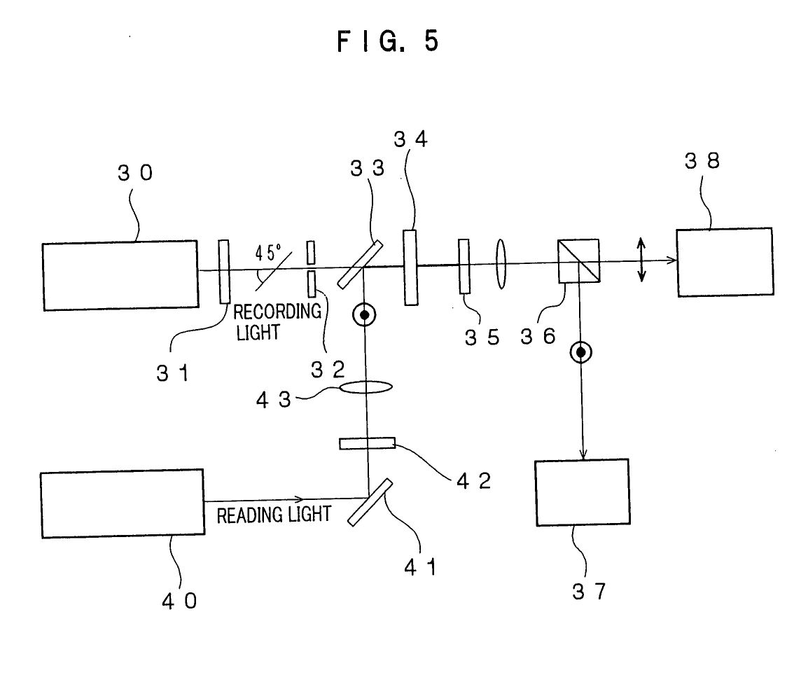

The optical system used for birefringent recording due to irradiation of linearly polarized light is shown in FIG. 5. As shown in FIG. 5, linearly polarized light (7.9 mW) with a wavelength of 515 nm sensitive to the polymer constituting the optical recording medium 34 is irradiated as recording light from an argon ion laser 30 via a ½ wavelength plate 31, a pinhole 32 with a diameter of 1 mm and a half-mirror 33. Linearly polarized light with a wavelength of 633 nm is irradiated as pumping light at an angle of 45° to the polarization axis from a helium-neon laser 40 via a mirror 41, ½ wavelength plate 42, lens 43 and half-mirror 33. The laser light permeating through the optical recording medium 34 is split into polarized light components having the polarization directions perpendicular to one another with a polarized beam splitter 36 after passing through an interference filter 35, and output intensities of respective polarized light components are measured with corresponding power meters 37 and 38. The change in birefringence is calculated from the polarization state of the transmission light using the measured values from the two power meters 37 and 38.

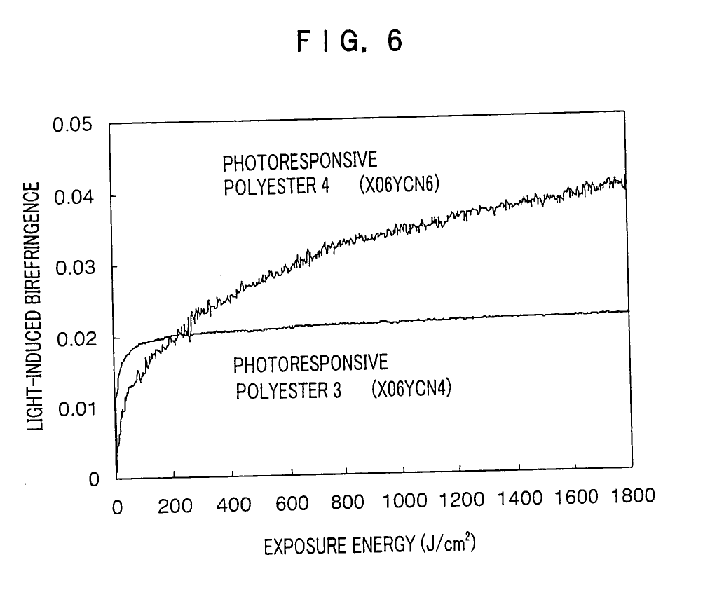

Birefringence is recorded on the optical recording media C and D prepared respective photoresponsive polyesters 3 and 4, respectively, using the optical system shown in FIG. 5. FIG. 6 shows the relation between the exposure light energy and light-induced birefringence. When both recording media are compared by noticing the sensitivity represented by initial slopes and dynamic ranges represented by saturation levels in the light-induced birefringence growth curves shown in the graph, photoresponsive polyester 3 (XO6YCN4) having a shorter spacer length in the side chain has a small dynamic range, although it is highly sensitive. On the other hand, photoresponsive polyester 4 (XO6YCN6) having a longer spacer length in the side chain has low sensitivity, although it has a large dynamic range. While both characteristics are important for improving the recording speed and recording density, making these characteristics compatible has been difficult in the conventional optical recording material, and it may concluded that control of the characteristics of the materials that can comply with required specifications is difficult.

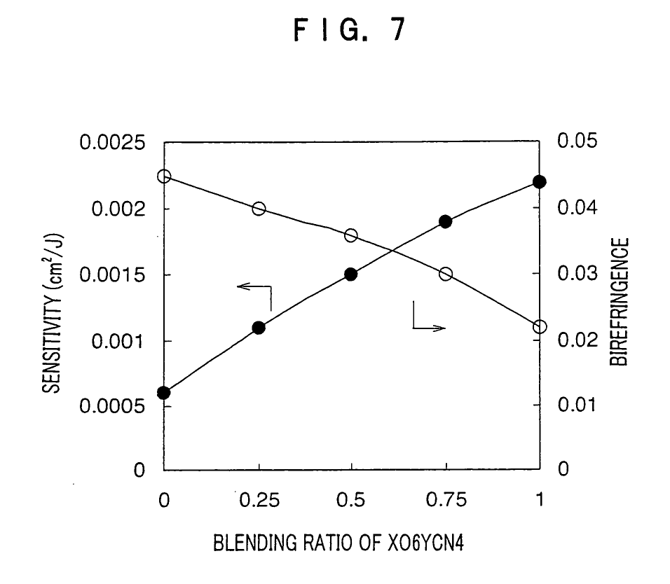

Birefringence is recorded in optical recording media E, F and G prepared by using the three kinds of the optical recording materials (polymer blends) of the invention and the optical recording media C and D by the same procedure as described above. FIG. 7 shows the relation between sensitivity and recorded birefringence values plotted against the blending ratio of XO6YCN4. As shown in FIG. 7, sensitivity and birefringence can be readily controlled by changing the blending ratio. The material can be readily designed depending on the required specification according to the invention.

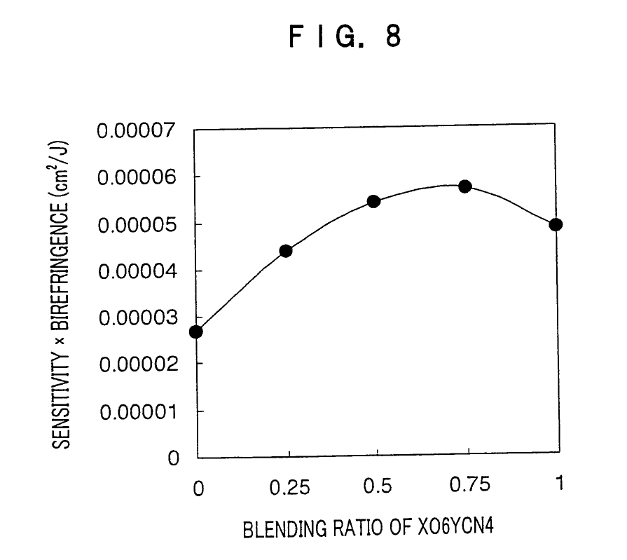

FIG. 8 shows a plot of (sensitivity×birefringence) against the blending ratio. While FIG. 8 suggests that both characteristics are compatible to one another as the value along the vertical axis is larger, it may be seen that the value of (sensitivity×birefringence) has a maximum against the blending ratio. Both sensitivity and dynamic range can be simultaneously improved by using the optical recording medium of the invention.

<Multiple Recording Property>

Examples of the design of the recording medium for obtaining an optical recording medium capable of high density recording with a high S/N ratio will be described below, wherein the optical recording medium is constructed so that the abundance ratio of side chains in which at least two kinds of spacer groups having different length with each other is changed in the polymer containing the photoresponsive groups in the thickness direction of the optical recording medium.

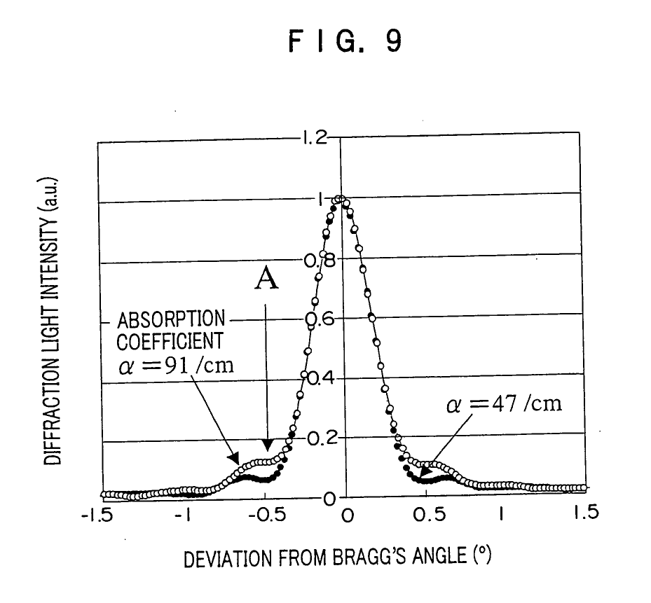

A Hologram is recorded on optical recording media H and I (conventional optical recording media) prepared with a thickness of 250 μm using a polymer blend comprising photoresponsive polyester 4 and a non-photoresponsive polyester in which all cyanoazobenzene in photoresponsive polyester 4 is substituted with cyanobiphenyl using the optical system shown in FIG. 3. FIG. 9 shows plots of diffraction light intensities obtained by impinging a laser beam with a wavelength of 633 nm to the hologram against the shift from an incident angle satisfying Bragg's condition. While absorption coefficient α of the optical recording medium shows the results of two different experiments, the diffraction light intensity is zero at an angle indicated by A in the graph in ideal cases. Signals from multiple recording can be read without cross-talk by recording another hologram at that angle. However, the diffraction light intensity at the angle indicated by A in the graph increases as the absorption coefficient of the optical recording material α is larger to cause cross-talk among the multiple recorded holograms as shown in FIG. 9.

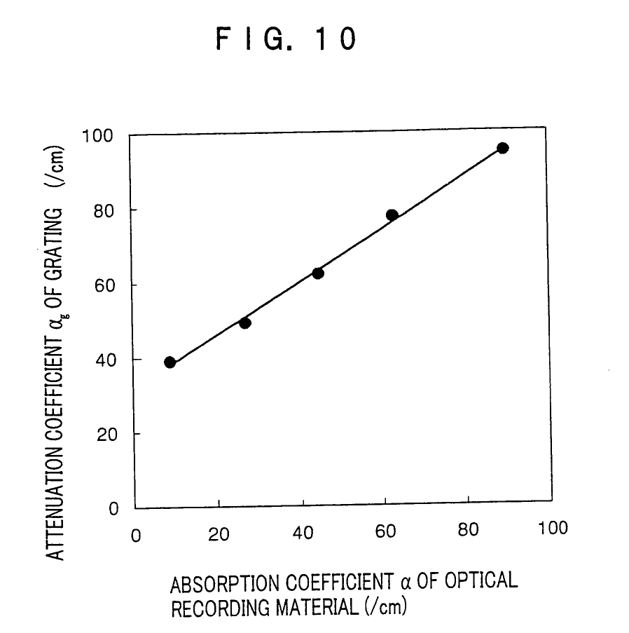

This effect is able to explain the results of experiments by introducing an attenuation coefficient α_{g} (attenuation coefficient of grating) of the amplitude of the refractive index in the thickness direction of the optical recording material into the theoretical equation described in the literature (N. Uchida, J. Opt. Soc. Am., 63, pp. 280-287, 1973). FIG. 10 shows the plots of the attenuation coefficient α_{g} of grating calculated using the theoretical equation against the absorption coefficient α of the optical recording material. The attenuation coefficient α_{g} of grating is approximately linear to the absorption coefficient α of the optical recording material. The graph shows that attenuation of grating results in attenuation of the recording light intensity due to absorption by the optical recording medium.

However, the optical recording medium of the invention is designed so that the abundance ratio of the photoresponsive group having shorter spacers increases in the depth direction from the surface of the film by changing the abundance ratio of the side chains in which at least two kinds of spacer groups having different lengths in the polymer containing the photoresponsive groups.

Since sensitivity to the light is higher as the side chain spacers are shorter as described in the light-induced birefringence characteristics in FIG. 6, a sufficient amplitude of the refractive index can be obtained even when the intensity of the recording light is attenuated by absorption of the medium. This permits the attenuation coefficient α_{g} of grating to be decreased to thereby decrease cross-talk of the multiple holograms. It is desirable for this purpose to change the abundance ratio of the side chain spacer length so that a product (I×S) of the recording light intensity I and sensitivity S is constant in the thickness direction of the film. Since the intensity I of the recording light at a depth x and the intensity I₀ of the recording light at the outermost surface is expressed by I=I₀exp(−αx), sensitivity S is desirably designed so as to be proportional to exp(αx) for obtaining a constant product I×S.

The optical recording medium of the invention is prepared using photoresponsive polyester 3 (XO6YCN4) and photoresponsive polyester 4 (XO6YCN6) based on the guideline described above. Each of the photoresponsive polyester polymers above is formed on a glass substrate by hot-pressing so that the thickness is 150 μm. Then, both substrates are mated so that one polymer surface contacts the other polymer surface with interposition of a film spacer with a thickness of 250 μm and pressed at the temperature of 70° C. to obtain the optical recording medium J.

A hologram is recorded on optical recording medium J from the photoresponsive polyester 4 (XO6YCN6) side using the optical system (optical recording/reproducing apparatus) shown in FIG. 3. The diffraction light intensity at a shift angle 0.5 relative to the diffraction light intensity when the light is impinged at a Bragg's angle can be reduced to 1/26 of the diffraction light intensity obtained in optical recording medium I prepared using only photoresponsive polyester 4 (XO6YCN6). The result shows that attenuation of the amplitude of the refractive index can be alleviated even when the recording light intensity is attenuated by absorption according to the invention, since the medium is designed so that sensitivity is higher at the position deep from the surface of the medium. This enables information from multiple holograms to be regenerated with a high S/N ratio.

1. An optical recording material which comprises at least one of a polymer and an oligomer, the at least one of a polymer and an oligomer comprising a photoresponsive group, wherein:
the optical recording material records information through change in at least one of absorption, refractive index and shape due to irradiation of light thereto;
a main chain of the at least one of a polymer and an oligomer has a side chain comprising a mesogenic unit linked thereto; and
the side chain comprises at least two flexible spacer groups introduced thereto, the spacer groups having lengths different from each other.

2. The optical recording material of claim 1, wherein all or a part of the mesogenic units are photoresponsive groups.

3. The optical recording material of claim 1, comprising a mixture of at least two kinds selected from polymers and oligomers each having a side chain comprising a flexible spacer group having lengths different from each other introduced thereto.

4. The optical recording material of claim 1, wherein:
the main chain comprises an organic group having a cyclic structure;
the side chain comprises the photoresponsive group and/or the mesogenic unit; and
all or a part of the side chain is linked to all or a part of the organic group having a cyclic structure.

5. The optical recording material of claim 1, wherein:
the at least one of a polymer and an oligomer comprises a side chain having a mesogenic unit that is a photoresponsive group and a side chain having a mesogenic unit that is a non-photoresponsive group, and
the spacer group of the side chain having a mesogenic unit that is a photoresponsive group and the spacer group of the side chain having a mesogenic unit that is a non-photoresponsive group have lengths that are different from each other.

6. The optical recording material of claim 5, wherein the length of the spacer group of the side chain having a mesogenic unit that is a photoresponsive group is shorter than the length of the spacer group of the side chain having a mesogenic unit that is a non-photoresponsive group.

7. The optical recording material of claim 1, wherein the photoresponsive group is contained in the optical recording material in an amount of approximately 20% by mass or less based on a mass of the optical recording material.

8. The optical recording material of claim 1, wherein the at least one of a polymer and an oligomer comprising a photoresponsive group is a compound represented by the following formula (1): 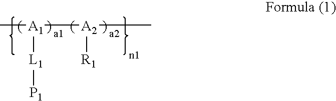
wherein L₁ represents a divalent linking group; R₁ represents a hydrogen atom or a substituent; P₁ represents a group comprising a photoresponsive group; a1 and a2 represent numbers in a range of 0.0001 to 1 and in a range of 0 to 0.9999, respectively, and satisfy a1+a2=1; n1 represents an integer in a range of 4 to 2000; and A₁ and A₂ each independently represent any one of the following formulae (2-1) to (2-4): 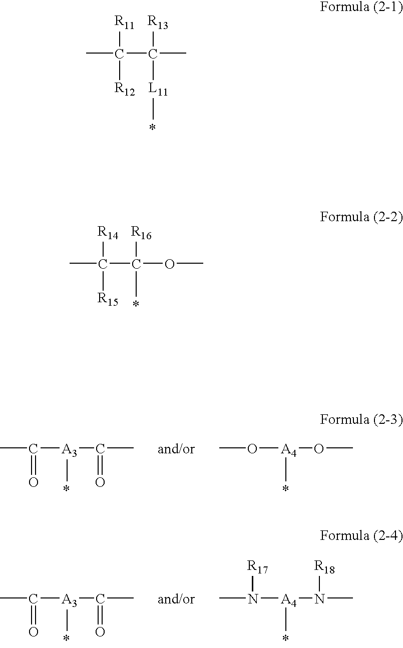
wherein each of the structures represented by formulae (2-1) to (2-4) is linked to L₁ or R₁ at a site represented by *; R₁₁ to R₁₃ each independently represent a hydrogen atom or a substituent; L₁₁ represents at least one selected from the group consisting of —O—, —OC(O)—, —CONR₁₉—, —COO— (the left side of each being linked to the polymeric main chain, and the right side of each being linked to L₁ or R₁) and a substituted or unsubstituted arylene group; R₁₉ represents at least one selected from the group consisting of a hydrogen atom, an alkyl group, an alkenyl group, a cycloalkyl group, an aryl group and a heterocyclic group; R₁₄ to R₁₆ each independently represent a hydrogen atom or a substituent; A₃ and A₄each independently represent a trivalent linking group; and R₁₇ and R₁₈ each independently represent at least one selected from the group consisting of a hydrogen atom, an alkyl group, an alkenyl group, a cycloalkyl group, an aryl group and a heterocyclic group.

9. An optical recording medium comprising a photosensitive layer including the optical recording material of claim 1.

10. The optical recording medium of claim 9, wherein the abundance ratio of the side chains in which at least two kinds of spacer groups having different lengths are introduced in the at least one of a polymer and an oligomer comprising a photoresponsive group changes in the thickness direction of the optical recording medium.

11. The optical recording medium of claim 10, wherein the abundance ratio of the side chains in which spacer groups having a shorter length are introduced in the at least one of a polymer and an oligomer comprising a photoresponsive group is increased in the direction of advance of recording light.

12. The optical recording medium of claim 9, wherein the photosensitive layer has a thickness in a range of approximately 20 μm to 10 mm.

13. The optical recording medium of claim 9, having a transmittance and/or a reflection ratio in a range of 40 to 80% at a wavelength of recording and/or reproducing light.

14. The optical recording medium of claim 9, wherein the optical recording medium is capable of hologram recording.

15. The optical recording medium of claim 9, wherein the optical recording medium is capable of independent hologram recording when the polarization directions of light incident to the medium and reference light are parallel with one another and when the polarization directions are perpendicular to one another.

16. The optical recording medium of claim 9, wherein the optical recording medium is capable of hologram recording based on the amplitude, phase and polarization direction of the light incident to the medium.

17. An optical recording/reproducing apparatus for recording and/or reproducing information using the optical recording medium of claim 9.
